(19) United States
(12) Patent Application Publication
(10) Pub. No.: US 2018/0081834 A1
(43) Pub. Date: Mar. 22, 2018

(54) APPARATUS AND METHOD FOR CONFIGURING HARDWARE TO OPERATE IN MULTIPLE MODES DURING RUNTIME

(71) Applicant: Futurewei Technologies, Inc., Plano, TX (US)

(72) Inventors: Qiang Wang, San Jose, CA (US); Zhuolei Wang, Shanghai (CN); Taneem Ahmed, Toronto (CA); Zhongpin Luo, Shanghai (CN); Qiang Li, Shanghai (CN)

(21) Appl. No.: 15/703,705

(22) Filed: Sep. 13, 2017

Related U.S. Application Data
(60) Provisional application No. 62/396,023, filed on Sep. 16, 2016.

(51) Int. Cl. G06F 13/20; G06F 13/42

(52) U.S. Cl. CPC G06F 13/20; G06F 13/42

(57) ABSTRACT

An apparatus and method are provided for configuring hardware to operate in multiple modes of operation during runtime. Included is a plurality of configurable hardware units each having a plurality of operand inputs for receiving operands, a plurality of outputs for outputting results, and at least one hardware unit configuration input for receiving at least one hardware unit configuration signal. Also included is a configurable interconnect fabric coupled between the configurable hardware units. The configurable interconnect fabric includes a plurality of fabric data inputs and fabric data outputs, and a fabric select input for receiving a fabric select signal. The configurable interconnect fabric is configured to interconnect the configurable hardware units, based on the fabric select signal. A configuration storage configured for containing at least one configuration bit pattern for operating the apparatus in one or more modes of operation and for configuring the hardware during runtime operations.

### RELATED APPLICATION(S)

The present application claims priority to a provisional application filed on Sep. 16, 2016, under Application Ser. No. 62/396,023, which is incorporated herein by reference in its entirety for all purposes.

### FIELD OF THE INVENTION

The present invention relates to configurable hardware, and more particularly to reconfiguring hardware for performing different operations.

### BACKGROUND

Reconfigurable hardware typically comes in many forms [e.g. field-programmable gate array (FPGA), programmable array logic (PAL), complex programmable logic device (CPLD), etc.]. Each of these types of hardware allow for configuration of the hardware so as to accommodate a particular application or use case scenario. While such hardware permits configuration, such configuration must be performed at set-up or initialization, before runtime operation is commenced.

### SUMMARY

An apparatus and method are provided for configuring hardware to operate in multiple modes of operation during runtime. Included is a plurality of configurable hardware units each having a plurality of operand inputs for receiving operands, a plurality of outputs for outputting results, and at least one hardware unit configuration input for receiving at least one hardware unit configuration signal. The configurable hardware units are each configured for performing computing operations and/or storage operations on at least a portion of the operands, based on the at least one hardware unit configuration signal.

Also included is a configurable interconnect fabric coupled between the configurable hardware units. The configurable interconnect fabric includes a plurality of fabric data inputs, a plurality of fabric data outputs, and at least one fabric select input for receiving at least one fabric select signal. The configurable interconnect fabric is configured to interconnect at least a portion of the fabric data outputs with the operand inputs of at least a portion of the configurable hardware units, based on the at least one fabric select signal. Still yet, the configurable interconnect fabric is configured to interconnect at least a portion of the fabric data inputs with the outputs of at least a portion of the configurable hardware units, based on the at least one fabric select signal.

Further provided is a configuration storage configured for containing a plurality of configuration bit patterns. Such configuration bit patterns include a first configuration bit pattern for generating a first hardware unit configuration signal and a first hardware unit fabric signal so as to operate at least a portion of the configurable hardware units and at least a portion of the configurable interconnect fabric in a first mode of operation during runtime. The configuration bit patterns further include a second configuration bit pattern for generating, during runtime, a second hardware unit configuration signal and a second hardware unit fabric signal so as to operate at least a portion of the configurable hardware units and at least a portion of the configurable interconnect fabric in a second mode of operation.

In a first embodiment, the configurable hardware units may include computing units for performing the computing operations.

In a second embodiment (which may or may not be combined with the first embodiment), the configurable hardware units may include data units for performing the storage operations. As an option, at least one of the data units stores data generated during the first mode of operation, while at least a portion of the configurable hardware units including the at least one data unit is being configured to operate in the second mode of operation, so that the data is available during the second mode of operation

In a third embodiment (which may or may not be combined with the first and/or second embodiments), the configurable interconnect fabric may include a plurality of multiplexers.

In a fourth embodiment (which may or may not be combined with the first, second, and/or third embodiments), a first portion of the apparatus may operate in the first mode of operation while a second portion of the apparatus operates in the second mode of operation, such that the apparatus simultaneously operates in the first mode of operation and the second mode of operation.

In a fifth embodiment (which may or may not be combined with the first, second, third, and/or fourth embodiments), the configurable hardware units may further include at least one synchronization input for receiving a synchronization signal to initiate the computing operations and/or the storage operations. As an option, different synchronization signals may be issued for different hardware units so as to coordinate the performance of the computing operations and/or the storage operations of the different hardware units.

In a sixth embodiment (which may or may not be combined with the first, second, third, fourth, and/or fifth embodiments), the at least portion of the configurable hardware units and the at least portion of the configurable interconnect fabric to operate in the first mode of operation may be the same as the at least portion of the configurable hardware units and the at least portion of the configurable interconnect fabric to operate in the second mode of operation, and thus may be reconfigured for operation in the second mode of operation.

In a seventh embodiment (which may or may not be combined with the first, second, third, fourth, fifth, and/or sixth embodiments), the at least portion of the configurable hardware units and the at least portion of the configurable interconnect fabric to operate in the first mode of operation may be different from the at least portion of the configurable hardware units and the at least portion of the configurable interconnect fabric to operate in the second mode of operation. As an option, a first portion of the configurable hardware units and/or the configurable interconnect fabric may be locked, while a second portion of the configurable hardware units and/or the configurable interconnect fabric is being configured to operate in the second mode of operation, such that the apparatus operates in the first mode of operation simultaneously with configuration of the apparatus to operate in the second mode of operation.

In an eighth embodiment (which may or may not be combined with the first, second, third, fourth, fifth, sixth, and/or seventh embodiments), the second configuration bit pattern may be loaded while the apparatus operates in the first mode of operation.

In a ninth embodiment (which may or may not be combined with the first, second, third, fourth, fifth, sixth, seventh, and/or eighth embodiments), the configuration storage may be further configured for containing a third configuration bit pattern for generating, during runtime, a third hardware unit configuration signal and a third hardware unit fabric signal for reconfiguring the at least portion of the configurable hardware units and the at least portion of the configurable interconnect fabric operating in the second mode of operation, so as to operate in a third mode of operation.

To this end, in some optional embodiments, one or more of the foregoing features of the aforementioned apparatus and/or method may provide configurable hardware units/interconnect fabric that may be reconfigured during runtime. This may, in turn, result in an increase in flexibility in chip design that would otherwise be foregone in systems that lack such runtime re-configurability. It should be noted that the aforementioned potential advantages are set forth for illustrative purposes only and should not be construed as limiting in any manner.

### BRIEF DESCRIPTION OF THE DRAWINGS

FIG. 1 illustrates an apparatus for being configured to operate in multiple modes of operation during runtime, in accordance with one embodiment.

FIG. 2 illustrates a method for configuring hardware to operate in multiple modes of operation during runtime, in accordance with one embodiment.

FIG. 3 illustrates an apparatus for being configured to operate in multiple modes of operation during runtime, in accordance with another embodiment.

FIG. 4 illustrates a configurable hardware unit for being configured to operate in multiple modes of operation during runtime, in accordance with another embodiment.

FIG. 5A illustrates a configurable apparatus configured to operate in a first mode of operation during runtime.

FIG. 5B illustrates the configurable apparatus of FIG. 5A configured, during runtime, to operate in a second mode of operation.

FIG. 6 illustrates a segment of configuration bit patterns for use in configuring hardware to operate in multiple modes of operation during runtime, in accordance with another embodiment.

FIG. 7 illustrates use of synchronization signals for coordinating operations of configurable hardware units, in accordance with another embodiment.

FIG. 8 illustrates a system for being configured to operate in multiple modes of operation during runtime, in accordance with one embodiment.

FIG. 9 is a diagram of a network architecture, in accordance with one embodiment.

FIG. 10 is a diagram of an exemplary system, in accordance with one embodiment.

### DETAILED DESCRIPTION

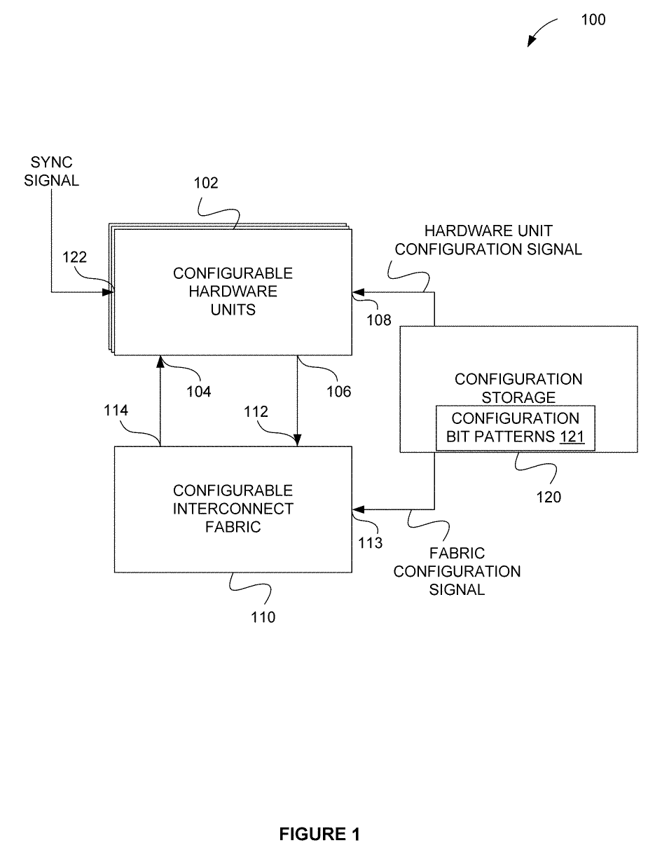

FIG. 1 illustrates an apparatus 100 for being configured to operate in multiple modes of operation during runtime, in accordance with one embodiment. As shown, a plurality of configurable hardware units 102 are included each with a plurality of operand inputs 104 for receiving operands, a plurality of outputs 106 for outputting results, and at least one hardware unit configuration input 108 for receiving at least one hardware unit configuration signal. Also included is a configurable interconnect fabric 110 coupled (e.g. directly, indirectly, etc.) between the configurable hardware units 102. The configurable interconnect fabric 110 includes a plurality of fabric data inputs 112, a plurality of fabric data outputs 114, and at least one fabric select input 113 for receiving at least one fabric select signal.

Also provided is a configuration storage 120 coupled (e.g. directly, indirectly, etc.) to the configurable hardware units 102, and the configurable interconnect fabric 110. In use, the configuration storage 120 is configured for storing instructions in the form of a plurality of configuration bit patterns 121 that permit configuration (including reconfiguration) of the configurable hardware units 102 and/or the configurable interconnect fabric 110 during runtime. More information will now be set forth regarding each of the foregoing components and the interoperation thereof.

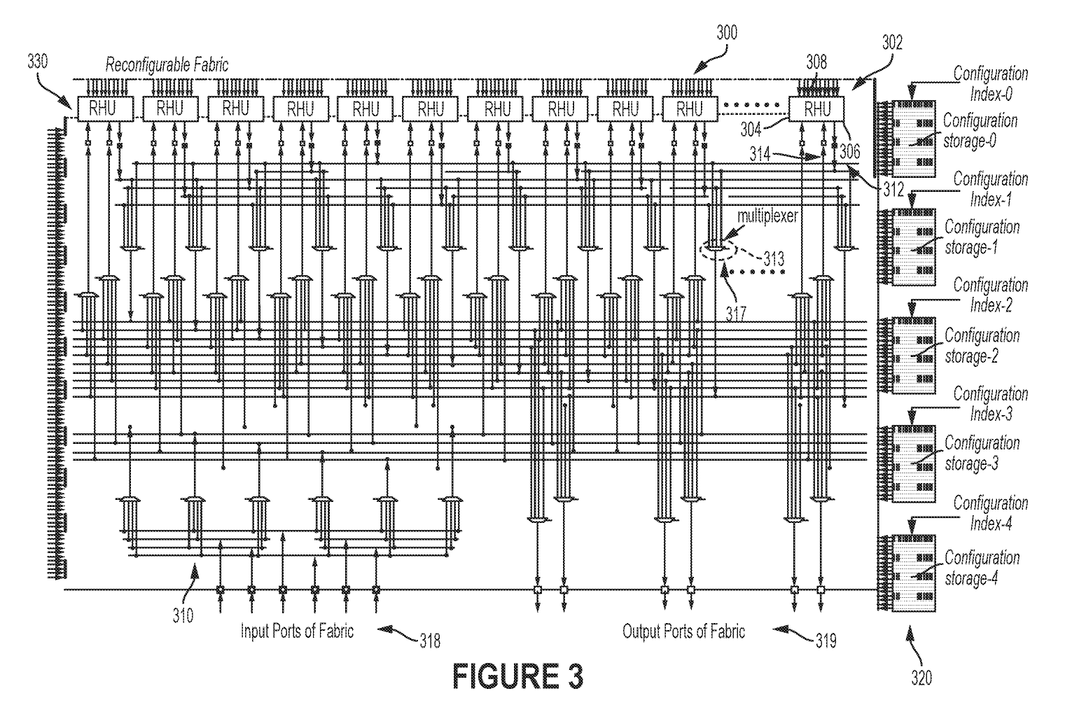

In the context of the present description, the configurable hardware units 102 may include any hardware that is capable of being reconfigured so that any input operands (i.e. any data, etc. as received through a data input port as shown in FIG. 3) may be operated upon to generate desired results. For example, in various optional embodiments, the configurable hardware units 102 may include one or more arithmetic logic units (ALUs) or any other desired logic units, storage (e.g. registers, buffers, etc.), and/or any other desired hardware. Thus, as will become apparent during the description of different subsequent embodiments, the configurable hardware units 102 may include computing units for performing computing operations, and/or data units for performing storage operations. Further, the configuration (including reconfiguration) of the configurable hardware units 102 may be based on the at least one hardware unit configuration signal received at the hardware unit configuration input 108 of the respective configurable hardware unit 102.

Also in the present description, the configurable interconnect fabric 110 may include any interconnect structure (e.g. connections at least a portion of which are configurable) that is capable of being configured (e.g. reconfigured, etc.) to interconnect at least a portion of the fabric data outputs 114 with the operand inputs 104 of at least a portion of the configurable hardware units 102, and/or to interconnect at least a portion of the fabric data inputs 112 with the outputs 106 of at least a portion of the configurable hardware units 102. To accomplish this, the configurable interconnect fabric 110 may, in various optional embodiments, include a plurality of multiplexers or any other interconnect structure(s) that may be reconfigured, as desired. During use, such configuration may be based on the at least one fabric select signal received at the fabric select input 113 of the configurable interconnect fabric 110.

To this end, the configurable hardware units 102 and/or the configurable interconnect fabric 110 may be configured and/or reconfigured. Further, such configurability may be performed during runtime, thereby permitting runtime configurability which, in the present description, refers to configuration and/or re-configuration of the aforementioned hardware to operate in different modes while such hardware is running. For example, in one embodiment, such runtime configurability may occur after compilation of software and/or embedded instructions, while such instructions are being executed by the hardware.

As mentioned earlier, the configuration storage 120 contains the configuration bit patterns 121 to configure (e.g. reconfigure, etc.) the configurable hardware units 102 and/or the configurable interconnect fabric 110 during runtime. To accomplish this, the configuration storage 120 may include any memory that is capable of storing the configuration bit patterns 121. Further, the configuration bit patterns 121 may include any digital data structure that is capable of being used to generate corresponding hardware unit configuration signals and/or hardware unit fabric signals. In one possible embodiment, the aforementioned signals may include a set of bits (e.g. 1's and O's, etc.) of the associated configuration bit patterns 121 that are delivered to the corresponding hardware in serial and/or parallel. In other embodiments, the aforementioned signals may be derived from the configuration bit patterns 121 in any desired manner.

In use, such configuration bit patterns 121 may include a first configuration bit pattern for generating a first hardware unit configuration signal and a first hardware unit fabric signal so as to operate at least a portion of the configurable hardware units 102 and at least a portion of the configurable interconnect fabric 110 in a first mode of operation during runtime. In one possible embodiment, the configuration that is carried out in response to the first hardware unit configuration signal and first hardware unit fabric signal, may occur before runtime (e.g. at set-up, initialization, etc.). In other possible embodiments, such configuration may be carried out during runtime.

The aforementioned configuration bit patterns 121 further include a second configuration bit pattern for generating, during runtime, a second hardware unit configuration signal and a second hardware unit fabric signal so as to operate at least a portion of the configurable hardware units 102 and at least a portion of the configurable interconnect fabric 110 in a second mode of operation. It should be noted that any number of hardware reconfigurations may be initiated during the same (or different) runtime instance. Just by way of example, the configuration storage 120 may be further configured for containing a third configuration bit pattern for generating, during runtime, a third hardware unit configuration signal and a third hardware unit fabric signal for reconfiguring the at least portion of the configurable hardware units 102 and the at least portion of the configurable interconnect fabric 110 operating in the second mode of operation, so as to operate in a third mode of operation.

It should be noted that the first and second modes of operation may or may not be executed simultaneously, at least in part. For example, in a first embodiment, the first mode operation may be executed before the second mode of operation, without any temporal overlap. In such embodiment, the portion(s) of the configurable hardware units 102 and the configurable interconnect fabric 110 to operate in the first mode of operation may possibly be the same as those to operate in the second mode of operation.

In another embodiment, the first mode operation may be executed during the second mode of operation, in parallel. In still other embodiments, a duration of the first mode operation may partially overlap that of the second mode of operation, such that portions of the first and second modes of operation overlap, while other portions do not. In such embodiment, the portion(s) of the configurable hardware units 102 and the configurable interconnect fabric 110 to operate in the first mode of operation may possibly be different from those to operate in the second mode of operation. Specifically, in one embodiment, a first portion of the apparatus 100 may operate in the first mode of operation while a second portion of the apparatus 100 operates in the second mode of operation, such that different portions of the apparatus 100 operate simultaneously (at least in part) in the first mode of operation and the second mode of operation, respectively. As further option, the first portion of the hardware (e.g. configurable hardware units 102 and/or the configurable interconnect fabric 110, etc.) may be locked, while the second portion of the hardware is being configured to operate in the second mode of operation, such that the apparatus 100 operates in the first mode of operation simultaneously with a configuration of the apparatus 100 to operate in the second mode of operation. More information regarding different embodiments that incorporate such feature(s) will be set forth during the description of subsequent figures.

In various optional embodiments, the configurable hardware units 102 may each further include at least one synchronization input 122 for receiving a synchronization signal to initiate the aforementioned computing operations and/or the storage operations. By this design, different synchronization signals may be issued for different hardware units 102 so as to coordinate the performance of the computing operations and/or the storage operations of the different hardware units 102. For example, a first one of the configurable hardware units 102 may be issued a corresponding synchronization signal to initiate a first operation (e.g. a first computing operation) during a first cycle to generate a first result, while a second one of the configurable hardware units 102 may be issued a different corresponding synchronization signal to initiate a second operation (e.g. a second computing operation) on the first result during a second cycle, in order to generate a second result. It should be noted that the configurable hardware units 102 may be configured to operate in parallel or in serial, and any output and/or input of data among different hardware units 102 may be controlled (i.e. initiated, allowed, etc.) by synchronization signals being directed to the individual hardware units 102. Further, it is contemplated that some configurable hardware units 102 may not necessarily be subject to synchronization signals and, thus, operate on a more static basis. Still yet, while not shown, the at least one synchronization input 122 may, in one embodiment, be coupled to a central controller (e.g. a processor, etc.) for permitting the issuance of the synchronization signal(s) from a central location.

To this end, in some optional embodiments, one or more of the foregoing features of the aforementioned configurable hardware units/interconnect fabric may, in turn, result in an increase in flexibility in chip design that would otherwise be foregone in systems that lack such runtime re-configurability. It should be noted that the aforementioned potential advantages are set forth for illustrative purposes only and should not be construed as limiting in any manner.

More illustrative information will now be set forth regarding various optional architectures and uses in which the foregoing method may or may not be implemented, per the desires of the user. For example, various embodiments will be described that may further enhance the aforementioned runtime re-configurability. Specifically, in one optional embodiment, the second configuration bit pattern may be loaded while the apparatus 100 operates in the first mode of operation. To this end, additional configuration bit patterns may be loaded during runtime, while operations are being executed based on previously-loaded configuration bit patterns.

As an additional option, data units of the configurable hardware units 102 may, in some embodiments, store data generated during the first mode of operation, while at least a portion of the configurable hardware units 102 (including the data units) and at least a portion of the configurable interconnect fabric 110 are being configured to operate in the second mode of operation. Strictly as an option, the data units may further perform some level of processing on the data (e.g. organizing data accessing patterns, acting as a data streaming unit, etc.), in addition to storing the same. Thus, even in the midst of reconfiguration of some of the hardware units 102, the data units of such hardware units 102 may remain untouched (at least temporarily) for storing data that may be used after such reconfiguration, thus allowing data to persist within the hardware units 102 during a reconfiguration thereof.

It should be noted that the following information regarding such feature(s) is set forth for illustrative purposes and should not be construed as limiting in any manner. Any of the following features may be optionally incorporated with or without the other features described.

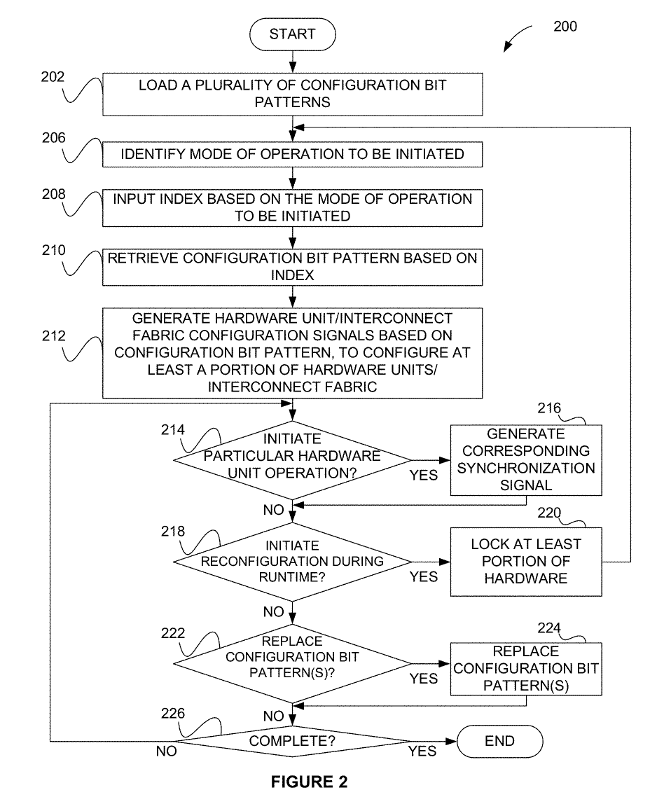

FIG. 2 illustrates a method 200 for configuring hardware to operate in multiple modes of operation during runtime, in accordance with one embodiment. As an option, the method 200 may be implemented in the context of any one or more of the embodiments set forth in any previous and/or subsequent figure(s) and/or description thereof. For example, in one possible embodiment, the method 200 may be implemented in the context of the apparatus 100 of FIG. 1. However, it is to be appreciated that the method 200 may be implemented in the context of any desired environment.

As shown, at step 202, a plurality of configuration bit patterns are loaded in a configuration storage (e.g. the configuration storage 120 of FIG. 1, etc.). In one embodiment, the configuration bit patterns may be loaded before runtime at initialization or set up.

In one possible embodiment, the foregoing configuration bit patterns may be generated based on a dataflow diagram. Such dataflow diagram may include any data structure that corresponds with a task, where such task includes a number of operations that are to be initiated in a certain order based on relative data relationships (e.g. dependencies, ordering, etc.). In use, the operations and/or data relationships associated with each dataflow diagram/task may be mapped to associated hardware (e.g. configurable hardware units 102 and/or configurable interconnect fabric 110 of FIG. 1, etc.), so that an appropriate bit pattern (e.g. word, etc.) may be generated to configure hardware to operate and communicate respective data to carry out the corresponding task. Thus, for example, if there are twenty (20) tasks to be performed by particular hardware, twenty (20) bit patterns will be stored in configuration storage for use during runtime.

With continuing reference to FIG. 2, a particular mode operation to be initiated may be identified at step 206. In various embodiments, step 206 may be carried out by higher level processing under the control of software (e.g. by inspecting incoming commands and/or data, etc.), and/or a user, in order to determine the manner in which the hardware is to be utilized. Further, in one embodiment, a default mode (e.g. a start-up mode) may be desired at start up.

In any case, at step 208, an index (e.g. address, etc.) is input into configuration storage (e.g. the configuration storage 120 of FIG. 1, etc.) based on the desired mode operation determined at step 206. Such index may thus serve to a look-up the appropriate configuration bit pattern, so that such configuration bit pattern is retrieved in 210. The configuration bit pattern may, in turn, be used to generate hardware unit/interconnect configuration signals, per step 212. For example, in one embodiment, the bits of the configuration bit pattern themselves may be communicated (e.g. serially or in parallel) to the appropriate hardware to configure the same.

Runtime operation may then be started, during which the initiation of operations of different hardware units may be coordinated. Specifically, it may be determined, in decision 214, whether operation of a particular hardware unit is to be initiated at a particular cycle. If so, a corresponding synchronization signal is generated and issued to the particular hardware unit at step 216. In various embodiments, control information describing the timing and/or order of the synchronization signals may be loaded with the configuration bit patterns at step 202. In other embodiments, such timing and/or order of the synchronization signals may be dictated by the aforementioned software (e.g. by inspecting incoming commands and/or data, etc.).

As mentioned earlier, different modes of operations corresponding to different subsets of the configuration bit patterns may be executed serially and/or in parallel. Further, during execution of at least one mode operation during runtime operation, various other functionality may simultaneously occur.

For example, various hardware (e.g. hardware units and/or interconnect fabric portions, etc.) may be reconfigured to carry out another task. Specifically, after a first operation has been completed using particular hardware, such particular hardware may be reconfigured using additional configuration bit patterns (or portions thereof) that were originally loaded at step 202. In such a scenario (and others), it may be determined, in decision 218, whether reconfiguration is to be initiated during runtime. In one embodiment, the decision 218 may be dynamically dictated by the data that is being processed and results thereof and/or commands received to prompt such processing. In other words, the aforementioned bit patterns may be stored in a predetermined order but retrieved and used (for reconfiguration) in a dynamically-determined order based on desired processing. In other embodiments, the decision 218 may follow a predetermined scheme (e.g. order, etc.) based on a timing of expected data processing. For instance, the aforementioned bit patterns may be stored in a predetermined order and retrieved and used (for reconfiguration) in such order, based on timing, triggering events, etc.

If it is determined in decision 218 that reconfiguration is to be initiated during runtime, at least a portion of the hardware may be locked in step 220. The portion of the hardware to be locked may be any portion that would be otherwise affected by the reconfiguration. For example, if a first hardware portion would output a result to a second hardware portion during reconfiguration of the second hardware portion, or if the first hardware portion requires an output from the second hardware portion during reconfiguration of the second hardware portion, the first hardware portion may be locked.

It should be noted that, during the foregoing hardware reconfiguration following step 220, data units of the hardware units being reconfigured may be used to store any intermediate data that was generated and/or stored prior to initiation of the reconfiguration. To this end, such stored data may persist through the reconfiguration process and be available to the reconfigured hardware and/or any other hardware units after reconfiguration during a subsequent mode of operation.

While some hardware units are operating on operands and/or while other hardware units are being reconfigured during runtime, it may be also determined, in decision 222, whether one or more of the configuration bit patterns should be replaced. For example, in one embodiment where the configuration storage has limited capacity, such storage may not necessarily have sufficient space for storing all required bit patterns. In such embodiment, when it is determined that additional configuration bit patterns are required per decision 222, one or more of the configuration bit patterns may be loaded in configuration storage (and thus replace one or more that have already been used or are known to be used less frequently), per step 224. Further, this may be accomplished during runtime while other operations are being executed based on already-loaded configuration bit patterns. In other embodiments, however, it is contemplated that the configuration storage has sufficient capacity for storing all bit patterns that are required for carrying out all or nearly all reconfigurations (or all operations of modes) that will be required during runtime.

With continuing reference to FIG. 2, the various decisions 214, 218, and 222 may be repeated as long as operation is incomplete and thus continuing per decision 226. In some possible embodiments, each of the steps of the method 200 may occur in real-time during runtime. For example, any step may occur during an initial one or more cycles while another step occurs during a subsequent one or more cycles immediately following the initial one or more cycles. Further, it is contemplated that any reconfiguration carried out by steps 220 and 206-212 may occur within a single cycle, so as to afford seamless transition from one mode of operation to another. Still yet, in other embodiments, any two or more steps of the method 200 may even occur during the same cycle insofar as there are no conflicts (e.g. data processing, input/output (I/O) conflicts, etc.).

FIG. 3 illustrates an apparatus 300 for being configured to operate in multiple modes of operation during runtime, in accordance with another embodiment. As an option, the apparatus 300 may be implemented in the context of any one or more of the embodiments set forth in any previous and/or subsequent figure(s) and/or description thereof. However, it is to be appreciated that the apparatus 300 may be implemented in the context of any desired environment.

As shown, a plurality of configurable hardware units 302 are included each with a plurality of operand inputs 304 for receiving operands, a plurality of outputs 306 for outputting results, and hardware unit configuration inputs 308 for receiving at least one hardware unit configuration signal. In use, the configuration (including reconfiguration) of the configurable hardware units 302 may be based on the at least one hardware unit configuration signal received at the hardware unit configuration input 308 of the respective configurable hardware unit 302. In one possible embodiment, this may be accomplished by the at least one hardware unit configuration signal prompting the selection, enabling, disabling, configuring, etc. of any components (e.g. computing units such an ALU, data units such as a register, etc.) so that the configurable hardware unit 302 operates in a certain manner.

Also included is a configurable interconnect fabric 310 coupled (e.g. directly, indirectly, etc.) between the configurable hardware units 302. The configurable interconnect fabric 310 includes a plurality of fabric data inputs 312 coupled to the outputs 306, a plurality of fabric data outputs 314 coupled to the operand inputs 304, and fabric select inputs 313 for receiving at least one fabric select signal. In one possible embodiment, the configurable interconnect fabric 310 may take the form of a generic reconfigurable routing structure (GRRS). Further, the configurable interconnect fabric 310 includes external inputs 318 and external outputs 319 for communicating input/output (I/O) with one or more external systems.

During use, the configurable interconnect fabric 310 may be configured based on the at least one fabric select signal that is received at the fabric select input 313 of each of a plurality of multiplexers 317 of the configurable interconnect fabric 310. In one possible embodiment, this may be accomplished via a select input 313 of each of a plurality of layers of the multiplexers 317 of the configurable interconnect fabric 310. For example, the multiplexers 317 may be organized into multiple layers between two I/O terminals of any possible connection. In use, select bits of each of the multiplexers 317 may represent a part of a particular bit pattern, and by setting values of all the bits in the pattern, the corresponding multiplexers 317 may together serve to make data connections between any pairs of terminals of the configurable hardware units 302.

Also provided is a configuration storage 320 configured for containing a plurality of configuration bit patterns that permit configuration/re-configuration of the configurable hardware units 302 and/or the configurable interconnect fabric 310 during runtime. In one embodiment, the configuration storage 320 may include a plurality of separate storage units, as shown, that are coupled to the hardware unit configuration inputs 308 and the fabric select inputs 313 for directing configuration signals thereto. For example, each bit pattern may be stored as a word, which is specified by an index number (e.g. address value) in the configuration storage 320. Further, reconfiguration may be realized by changing the value of the index, which results in a different configuration bit pattern being read out of the configuration storage 320.

Still yet, synchronization signals 330 may be directed to any individual configurable hardware unit 302 (and even the interconnect fabric 310) for initiating the operation of the configurable hardware unit 302 (or component thereof, e.g. computing unit, data unit, etc.), so as to coordinate operation of the configurable hardware units 302, as well as the I/O thereof. To this end, in one embodiment, the apparatus 300 may configure the configurable hardware units 302 and the configurable interconnect fabric 310 utilizing the method 200 of FIG. 2, or any other desired technique. More information will be set forth regarding the design of one possible configurable hardware unit.

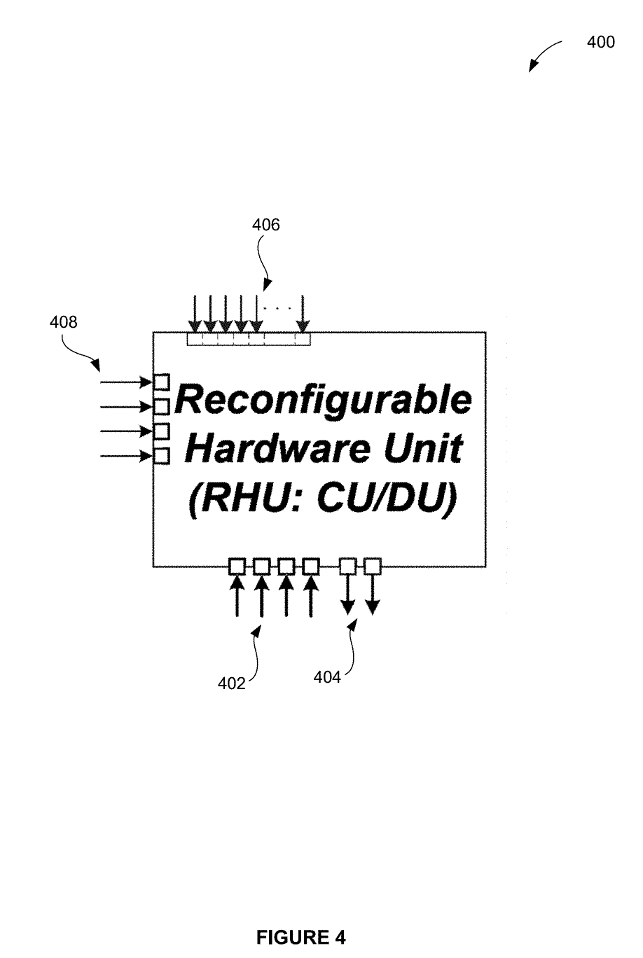

FIG. 4 illustrates a configurable hardware unit 400 for being configured to operate in multiple modes of operation during runtime, in accordance with another embodiment. As an option, the configurable hardware unit 400 may be implemented in the context of any one or more of the embodiments set forth in any previous and/or subsequent figure(s) and/or description thereof. For example, the configurable hardware unit 400 may be implemented in the context of the configurable hardware units 102 of FIG. 1 and/or the configurable hardware units 302 of FIG. 3. However, it is to be appreciated that the configurable hardware unit 400 may be implemented in the context of any desired environment.

As shown, the configurable hardware unit 400 includes operand inputs 402 for data connections, outputs 404, as well as hardware unit configuration inputs 406 for configuring the functionality of the configurable hardware unit 400. The configurable hardware unit 400 further includes synchronization inputs 408 in the form of additional pins for synchronizing operations inside the configurable hardware unit 400 with an external system (e.g. other configurable hardware unit, etc.).

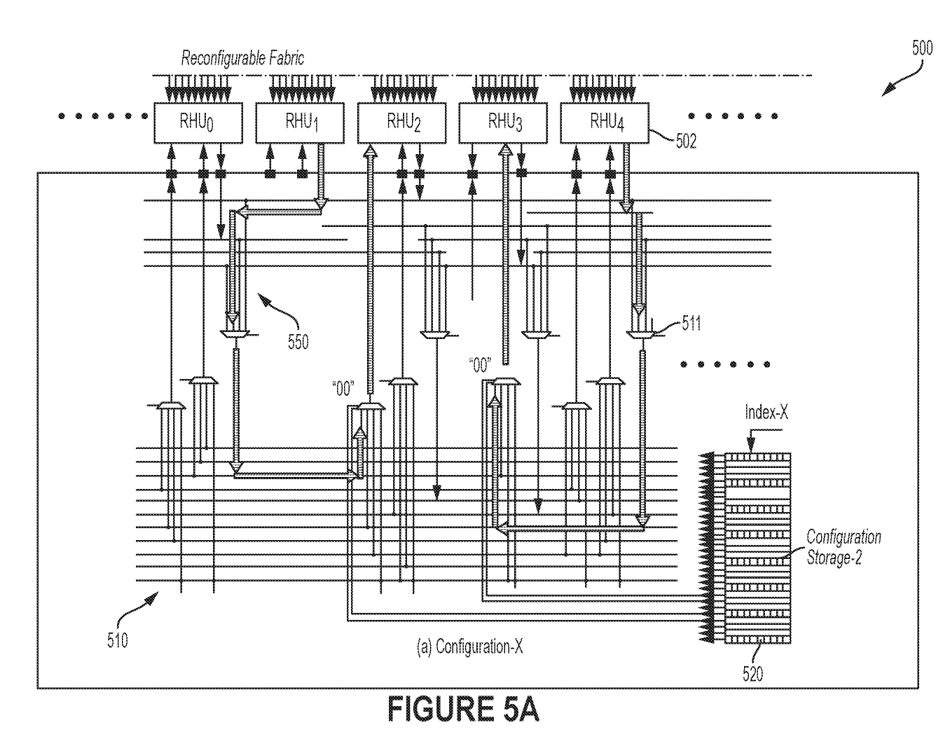

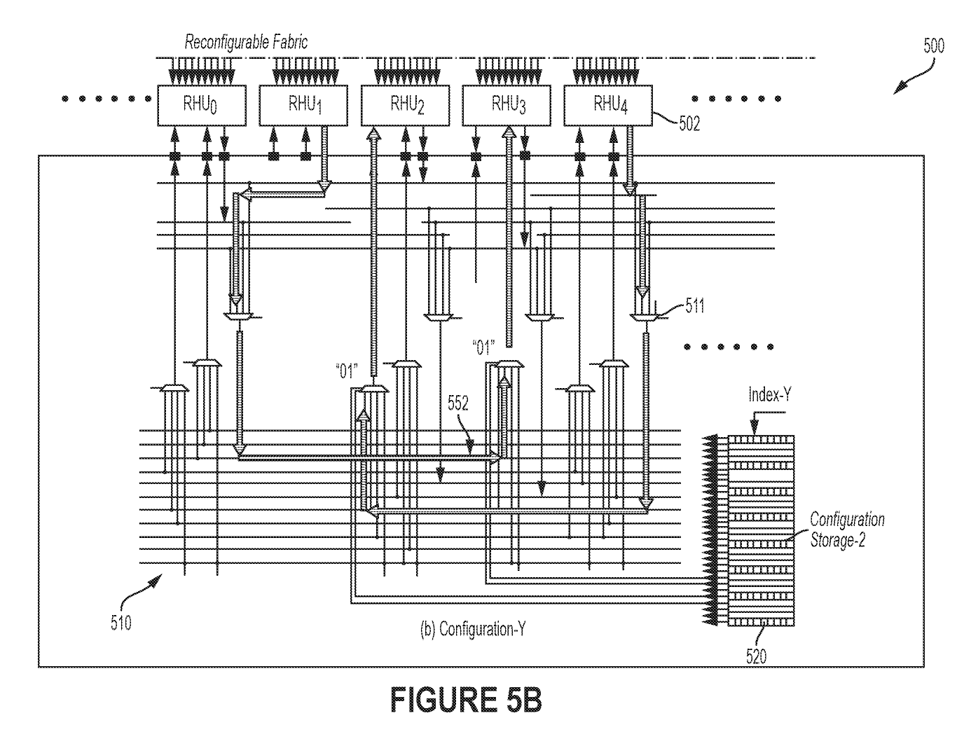

FIG. 5A illustrates a configurable apparatus 500 configured to operate in a first mode of operation during runtime. Similar to previous embodiments, the configurable apparatus 500 includes configurable hardware units 502, a configurable interconnect fabric 510 including a plurality of multiplexers 511, and a configuration storage 520. Further, FIG. 5B illustrates the configurable apparatus 500 of FIG. 5A configured, during runtime, to operate in a second mode of operation.

As illustrated by way of hatching, the apparatus 500 is shown in FIG. 5A to direct data via a first path 550 of the configurable interconnect fabric 510, in response to an index X being input into the configuration storage 520. Further, in FIG. 5B, the apparatus 500 is shown to direct data via a second path 552 of the configurable interconnect fabric 510, in response to an index Y being input into the configuration storage 520. While not shown, the configurable hardware units 502 of FIG. 5A may be configured to operate differently with respect to the configurable hardware units 502 of FIG. 5B.

Thus, two examples of connecting schemes are presented, in which pin-to-pin connections are made by selecting the multiplexers 511 with specific values. Such two schemes are specified by two configuration bit patterns that are stored at two locations in the configuration storage 520. Further, two index values, “Index-X” or “Index-Y”, are used as addresses to read out the appropriate configuration bit patterns. To this end, the configurable interconnect fabric 510 may be used to implement a dataflow diagram by configuring the configurable hardware units 502 for implementing various functions of nodes in the diagram and configuring the routing multiplexers 511 to create all the tailored data connections among the nodes.

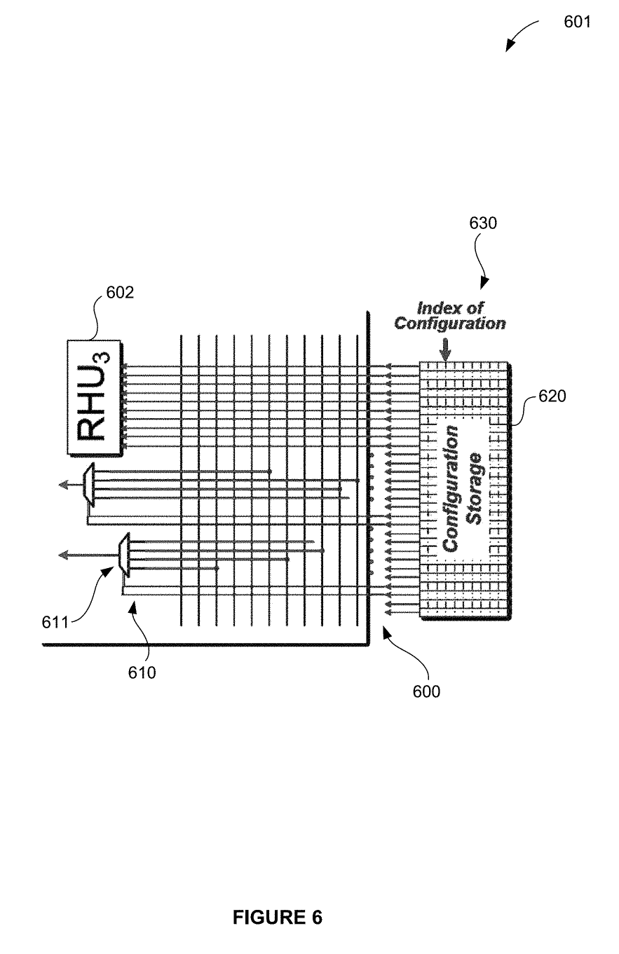

FIG. 6 illustrates a segment of configuration bit patterns 600 for use in configuring hardware to operate in multiple modes of operation during runtime, in accordance with another embodiment. As an option, the configuration bit patterns 600 may be implemented in the context of any one or more of the embodiments set forth in any previous and/or subsequent figure(s) and/or description thereof. However, it is to be appreciated that the configuration bit patterns 600 may be implemented in the context of any desired environment.

Similar to previous embodiments, FIG. 6 shows a configurable apparatus 601 including one of a plurality of configurable hardware units 602, a configurable interconnect fabric 610 including a plurality of multiplexers 611, and a configuration storage 620. As mentioned earlier, such configuration storage 620 may include any piece of memory, or a set of registers. Each memory word, or a register, stores a number of configuration bits that specifies connecting patterns through a number of the multiplexers 611 for data connections among the configurable hardware units 602 (via the configurable interconnect fabric 610), as well as functionalities of the configurable hardware units 602. The address lines of the memory, or register select lines, are further controlled by Index of Configuration signals 630.

By changing the Index of Configuration signals 630, the connectivity among the configurable hardware units 602 and the functionalities of the configurable hardware units 602 may be changed from one mode to another. Such dynamic reconfiguration of the configurable interconnect fabric 610 may be carried out by changing a value of the Index of Configuration signals 630. For the configurable interconnect fabric 610, multiple configuration storage 620 may be used, in some embodiments, so that by changing the address lines (the Index of Configuration signal 630) on each configuration storage 620 independently, one may partially change functions implemented by the configurable interconnect fabric 610.

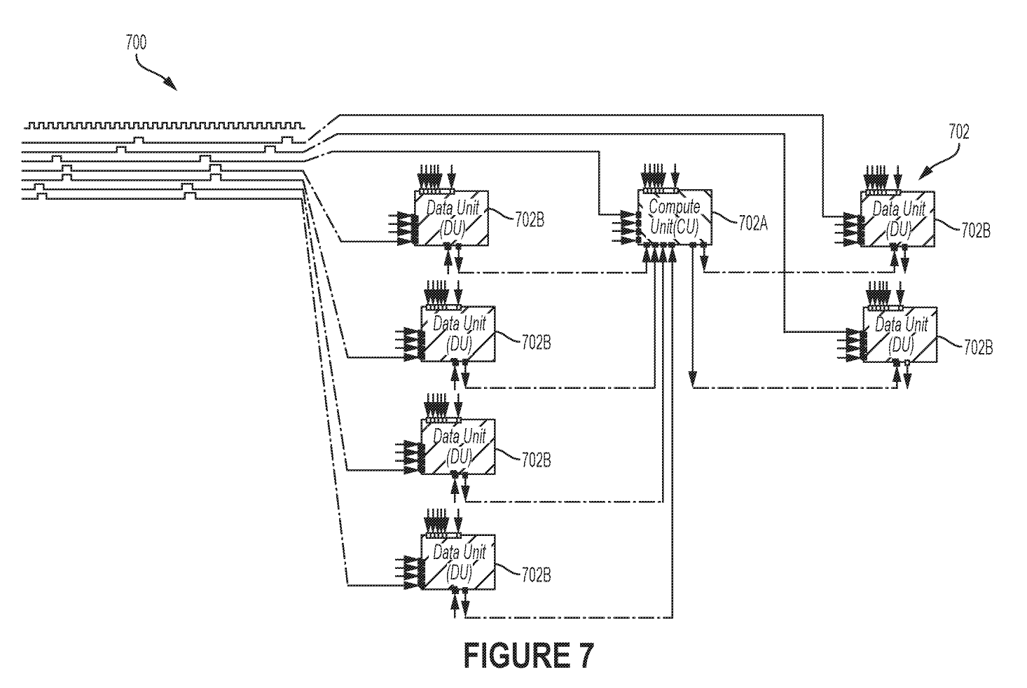

FIG. 7 illustrates use of synchronization signals 700 for coordinating operations of configurable hardware units 702, in accordance with another embodiment. As an option, such use of synchronization signals 700 may be implemented in the context of any one or more of the embodiments set forth in any previous and/or subsequent figure(s) and/or description thereof. However, it is to be appreciated that the use of synchronization signals 700 may be implemented in the context of any desired environment.

As shown, the configurable hardware units 702 may include computing units 702A as well as data units 704B. To minimize control dependencies and signal activities, execution controlling functions are distributed into the individual configurable hardware units 702. Thus, a system need only to send the synchronization signals 700 to start a sequence on each configurable hardware unit 702. In other words, a synchronization signal 700 may be responsible for a sequence of execution on the corresponding configurable hardware unit 702. With such global synchronization scheme, there may, in some embodiments, not necessarily be a need for any control-related interactions between any two configurable hardware units 702. For example, there may not necessarily be a need for status and/or trigger signals (e.g. handshakes, etc.) to occur among the configurable hardware units 702 to coordinate operation among the same.

By this design, in some embodiments, runtime reconfigurable hardware may be used to achieve very high performances via customized hardware features, which are tailored for the corresponding tasks, and improve efficiency of performance over the cost of power and silicon area. Each of the tailored modes may be configured (e.g. implemented, etc.) by a binary bit pattern. Further, by changing among different bit patterns, the hardware units may be effectively changed from one mode to another. Thus, usage scenarios may be categorized into separated modes, for each of which the configurable hardware units may be configured with corresponding efficient functional modes. Further, by switching the modes of the configurable hardware units, an overall system may offer optimal performances to all such usage scenarios.

As mentioned earlier, in some possible embodiments, object tasks may be customized into an optimized implementation on reconfigurable fabric, thus reducing data accesses to shared storages, and minimizing control hand-shaking and dependencies. The object tasks, before being mapped onto the reconfigurable fabric, may be represented in a dataflow diagram. Such diagram may be constructed utilizing a number of operation nodes, and a number of data connections. Each of the nodes may have several input ports, each of which represents one operand of the operation represented by the node, and several output ports, each of which represents one of the results generated by the node operation. Each of the data connections affords a link from an output port on a source node to an input port on a destination node.

To this end, a dataflow diagram may be utilized which represents a series of operations for a task. Specifically, such dataflow diagram may be mapped on the configurable interconnect fabric. Further, data units may be used to reduce data movement during executions on the aforementioned fabric, in order to avoid accessing shared memory. Still yet, a global synchronization scheme may be used to eliminate control latencies, by eliminating some or all control interaction between configurable hardware units, so as to minimize signal activities for control logic. Even still, configuration storage may be used to enable runtime reconfigurations on the same fabric during execution.

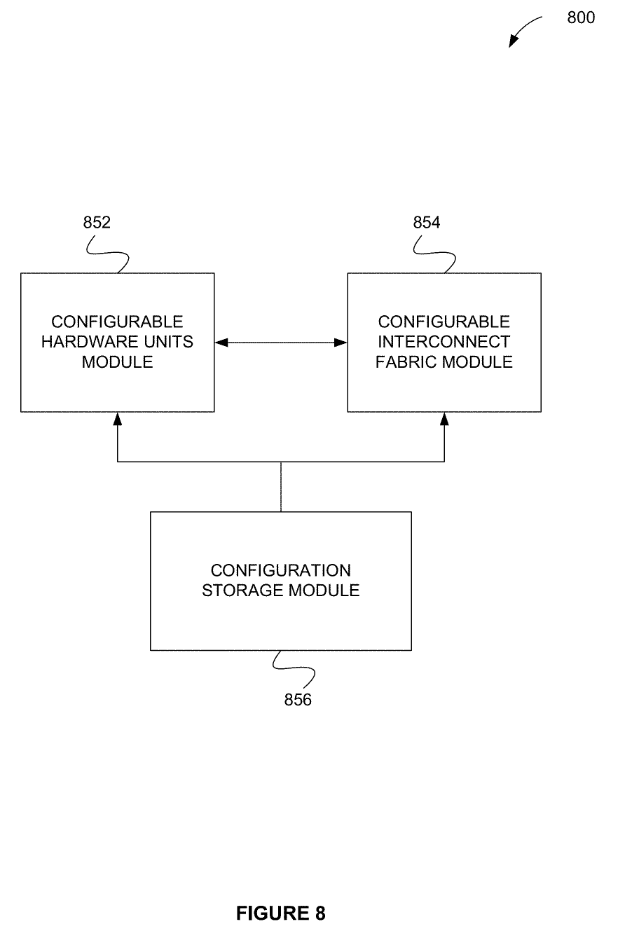

FIG. 8 illustrates a system 800 for being configured to operate in multiple modes of operation during runtime, in accordance with one embodiment. As an option, the system 800 may be implemented with one or more features of any one or more of the embodiments set forth in any previous and/or subsequent figure(s) and/or the description thereof. However, it is to be appreciated that the system 800 may be implemented in the context of any desired environment.

As shown, a configurable hardware units means in the form of a configurable hardware units module 852 is provided including a plurality of configurable hardware units for operating (e.g. computing, storing, etc.) on data. In various embodiments, the configurable hardware units module 852 may include, but is not limited to the configurable hardware units 102 of FIG. 1, the configurable hardware units 302 of FIG. 3, and/or any other circuitry capable of the aforementioned functionality.

Also included is a configurable interconnect fabric means in the form of a configurable interconnect fabric module 854 in communication with the configurable hardware units module 852 for providing configurable communication between the configurable hardware units module 852. In various embodiments, the configurable interconnect fabric module 854 may include, but is not limited to the configurable interconnect fabric 110 of FIG. 1, the configurable interconnect fabric 310 of FIG. 3, and/or any other circuitry capable of the aforementioned functionality.

With continuing reference to FIG. 8, configuration storage means in the form of a configuration storage module 856 is in communication with the configurable interconnect fabric module 854 and the configurable hardware units module 852 for generating signals during runtime to configure the configurable hardware units module 852 and/or the configurable interconnect fabric module 854. In various embodiments, the configuration storage module 856 may include, but is not limited to the configuration storage 120 of FIG. 1, the configuration storage 320 of FIG. 3, at least one processor (to be described later) and any software controlling the same, and/or any other circuitry capable of the aforementioned functionality.

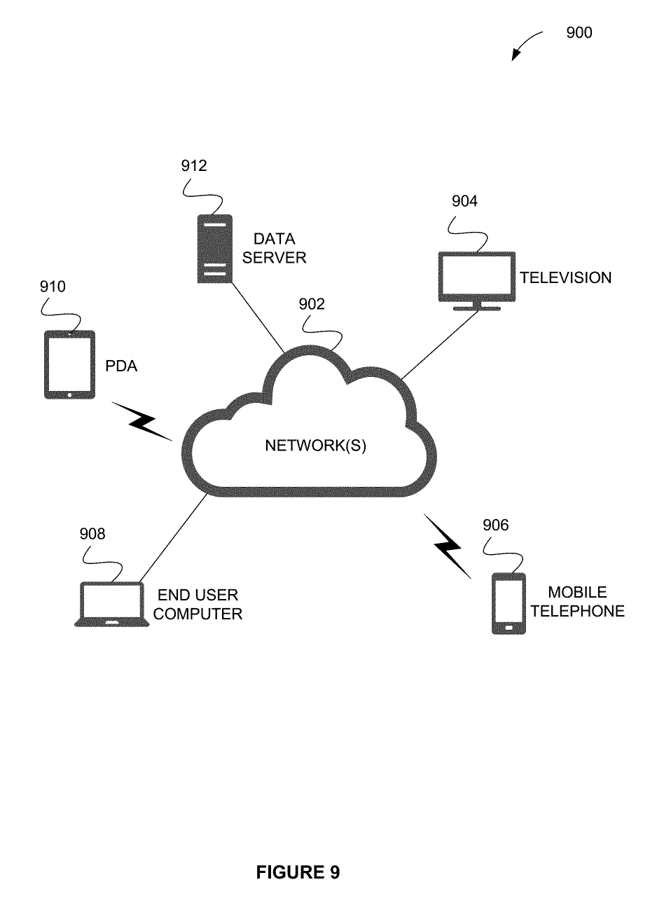

FIG. 9 is a diagram of a network architecture 900, in accordance with one embodiment. As shown, at least one network 902 is provided. In various embodiments, any one or more components/features set forth during the description of any previous figure(s) may be implemented in connection with any one or more of the components of the at least one network 902.

In the context of the present network architecture 900, the network 902 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 902 may be provided.

Coupled to the network 902 is a plurality of devices. For example, a server computer 912 and a computer 908 may be coupled to the network 902 for communication purposes. Such computer 908 may include a desktop computer, lap-top computer, and/or any other type of logic. Still yet, various other devices may be coupled to the network 902 including a personal digital assistant (PDA) device 910, a mobile phone device 906, a television 904, etc.

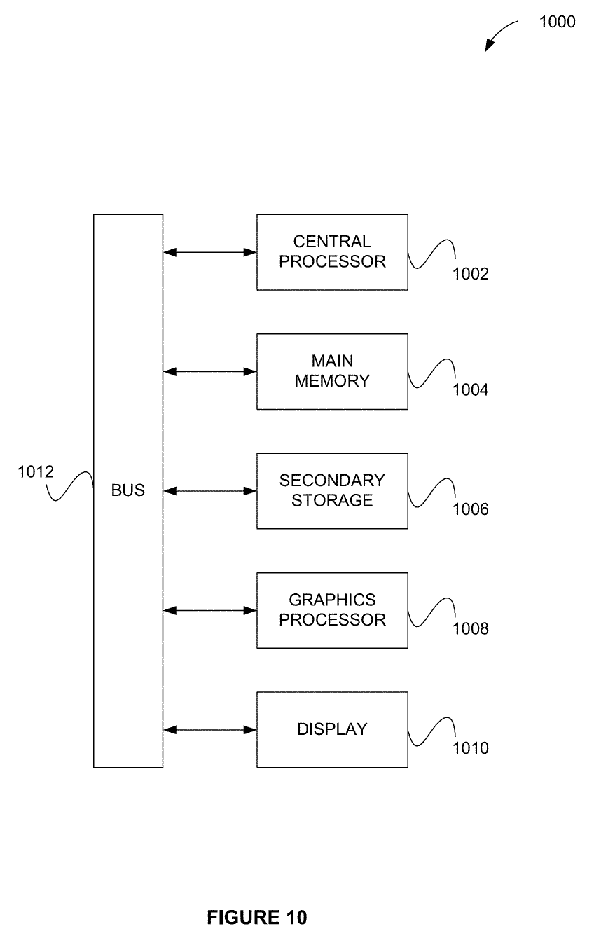

FIG. 10 is a diagram of an exemplary system 1000, in accordance with one embodiment. As an option, the system 1000 may be implemented in the context of any of the devices of the network architecture 900 of FIG. 9. However, it is to be appreciated that the system 1000 may be implemented in any desired environment.

As shown, a system 1000 is provided including at least one processor 1002 which is connected to a bus 1012. The system 1000 also includes memory 1004 [e.g., hard disk drive, solid state drive, random access memory (RAM), etc.]. The memory 1004 may include one or more memory components, and may even include different types of memory. The system 1000 also includes a display 1010 in the form of a touchscreen, separate display, or the like. Further included is a graphics processor 1008 coupled to the display 1010.

The system 1000 may also include a secondary storage 1006. The secondary storage 1006 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 1004, the secondary storage 1006, and/or any other memory, for that matter. Such computer programs, when executed, enable the system 1000 to perform various functions (as set forth above, for example). Memory 1004, secondary storage 1006 and/or any other storage comprise non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. An apparatus, comprising:
a plurality of configurable hardware units each including a plurality of operand inputs for receiving operands, a plurality of outputs for outputting results, and at least one hardware unit configuration input for receiving at least one hardware unit configuration signal, the configurable hardware units each configured to perform at least one of computing operations or storage operations on at least a portion of the operands, based on the at least one hardware unit configuration signal;
a configurable interconnect fabric coupled between the configurable hardware units and including a plurality of fabric data inputs, a plurality of fabric data outputs, and at least one fabric select input for receiving at least one fabric select signal, the configurable interconnect fabric configured to interconnect a selective subset of the configurable hardware units using at least a portion of the fabric data outputs connected with the operand inputs of the configurable hardware units and at least a portion of the fabric data inputs connected with the outputs of the configurable hardware units, based on the at least one fabric select signal; and
a configuration storage coupled to the configurable hardware units and the configurable interconnect fabric, the configuration storage configured to contain a plurality of configuration bit patterns including a first configuration bit pattern for generating a first hardware unit configuration signal and a first hardware unit fabric signal so as to operate at least a portion of the configurable hardware units and at least a portion of the configurable interconnect fabric in a first mode of operation during runtime, and a second configuration bit pattern for generating, during runtime, a second hardware unit configuration signal and a second hardware unit fabric signal so as to operate at least a portion of the configurable hardware units and at least a portion of the configurable interconnect fabric in a second mode of operation.

2. The apparatus of claim 1, wherein the configurable hardware units include computing units for performing the computing operations.

3. The apparatus of claim 1, wherein the configurable hardware units include data units for performing the storage operations.

4. The apparatus of claim 3, wherein the apparatus is configured such that at least one of the data units stores data generated during the first mode of operation, while at least a portion of the configurable hardware units including the at least one data unit is being configured to operate in the second mode of operation, so that the data is available during the second mode of operation.

5. The apparatus of claim 1, wherein the configurable interconnect fabric includes a plurality of multiplexers.

6. The apparatus of claim 1, wherein the apparatus is configured such that a first portion of the apparatus operates in the first mode of operation while a second portion of the apparatus operates in the second mode of operation, such that the apparatus simultaneously operates in the first mode of operation and the second mode of operation.

7. The apparatus of claim 1, wherein the configurable hardware units further include at least one synchronization input for receiving a synchronization signal to initiate at least one of the computing operations or the storage operations.

8. The apparatus of claim 7, wherein the apparatus is further configured to issue different synchronization signals for different hardware units so as to coordinate the performance of at least one of the computing operations or the storage operations of the different hardware units.

9. The apparatus of claim 1, wherein the at least portion of the configurable hardware units and the at least portion of the configurable interconnect fabric to operate in the first mode of operation are the same as the at least portion of the configurable hardware units and the at least portion of the configurable interconnect fabric to operate in the second mode of operation.

10. The apparatus of claim 1, wherein the at least portion of the configurable hardware units and the at least portion of the configurable interconnect fabric to operate in the first mode of operation are different from the at least portion of the configurable hardware units and the at least portion of the configurable interconnect fabric to operate in the second mode of operation.

11. The apparatus of claim 10, wherein the apparatus is further configured to lock a first portion of at least one of the configurable hardware units or the configurable interconnect fabric, while a second portion of at least one of the configurable hardware units or the configurable interconnect fabric is being configured to operate in the second mode of operation, such that the apparatus operates in the first mode of operation simultaneously with configuration of the apparatus to operate in the second mode of operation.

12. The apparatus of claim 1, wherein the apparatus is further configured to load the second configuration bit pattern while the apparatus operates in the first mode of operation.

13. The apparatus of claim 1, wherein the configuration storage is further configured for containing a third configuration bit pattern for generating, during runtime, a third hardware unit configuration signal and a third hardware unit fabric signal for reconfiguring the at least portion of the configurable hardware units and the at least portion of the configurable interconnect fabric operating in the second mode of operation, so as to operate in a third mode of operation.

14. A method, comprising:
storing a plurality of configuration bit patterns utilizing a configuration storage that is coupled to a plurality of configurable hardware units and a configurable interconnect fabric,
the plurality of configurable hardware units each including a plurality of operand inputs for receiving operands, a plurality of outputs for outputting results, and at least one hardware unit configuration input for receiving at least one hardware unit configuration signal, and each configured for performing at least one of computing operations or storage operations on at least a portion of received operands based on at least one received hardware unit configuration signal,
the configurable interconnect fabric coupled between the configurable hardware units and including a plurality of fabric data inputs, a plurality of fabric data outputs, and at least one fabric select input for receiving at least one fabric select signal, and the configurable interconnect fabric configured to interconnect a selective subset of the configurable hardware units using at least a portion of the fabric data outputs connected with the operand inputs of the configurable hardware units and at least a portion of the fabric data inputs connected with the outputs of the configurable hardware units, based on the at least one fabric select signal;
generating a first hardware unit configuration signal and a first hardware unit fabric signal, utilizing a first configuration bit pattern, so as to operate at least a portion of the configurable hardware units and at least a portion of the configurable interconnect fabric in a first mode of operation during runtime; and
generating, during runtime, a second hardware unit configuration signal and a second hardware unit fabric signal, utilizing a second configuration bit pattern, so as to operate at least a portion of the configurable hardware units and at least a portion of the configurable interconnect fabric in a second mode of operation.

15. The method of claim 14, wherein the configurable hardware units include computing units for performing the computing operations.

16. The method of claim 14, wherein the configurable hardware units include data units for performing the storage operations.

17. The method of claim 16, and further comprising storing data generated during the first mode of operation using at least one of the data units, while at least a portion of the configurable hardware units including the at least one data unit is being configured to operate in the second mode of operation, so that the data is available during the second mode of operation.

18. The method of claim 14, wherein the configurable interconnect fabric includes a plurality of multiplexers.

19. The method of claim 14, and further comprising operating in the first mode of operation while operating in the second mode of operation, to simultaneously operate in the first mode of operation and the second mode of operation.

20. The method of claim 14, and further comprising receiving a synchronization signal at one or more of the configurable hardware units to initiate at least one of the computing operations or the storage operations.

21. The method of claim 20, and further comprising issuing different synchronization signals for different hardware units so as to coordinate the performance of at least one of the computing operations or the storage operations of the different hardware units.

22. The method of claim 14, wherein the at least portion of the configurable hardware units and the at least portion of the configurable interconnect fabric to operate in the first mode of operation are the same as the at least portion of the configurable hardware units and the at least portion of the configurable interconnect fabric to operate in the second mode of operation.

23. The method of claim 14, wherein the at least portion of the configurable hardware units and the at least portion of the configurable interconnect fabric to operate in the first mode of operation are different from the at least portion of the configurable hardware units and the at least portion of the configurable interconnect fabric to operate in the second mode of operation.

24. The method of claim 23, and further comprising locking a first portion of at least one of the configurable hardware units or the configurable interconnect fabric, while a second portion of at least one of the configurable hardware units or the configurable interconnect fabric is being configured to operate in the second mode of operation, such that the apparatus operates in the first mode of operation simultaneously with configuration of the apparatus to operate in the second mode of operation.

25. The method of claim 14, and further comprising loading the second configuration bit pattern while operating in the first mode of operation.

26. The method of claim 14, and further comprising generating, during runtime, a third hardware unit configuration signal and a third hardware unit fabric signal for reconfiguring the at least portion of the configurable hardware units and the at least portion of the configurable interconnect fabric operating in the second mode of operation, so as to operate in a third mode of operation.

27. A device, comprising:
a plurality of configurable hardware units each including a plurality of operand inputs for receiving operands, a plurality of outputs for outputting results, and at least one hardware unit configuration input for receiving at least one hardware unit configuration signal, the configurable hardware units each configured to perform at least one of computing operations or storage operations on at least a portion of the operands, based on the at least one hardware unit configuration signal;
a configurable interconnect fabric coupled between the configurable hardware units and including a plurality of fabric data inputs, a plurality of fabric data outputs, and at least one fabric select input for receiving at least one fabric select signal, the configurable interconnect fabric configured to interconnect a selective subset of the configurable hardware units using at least a portion of the fabric data outputs connected with the operand inputs of the configurable hardware units and at least a portion of the fabric data inputs connected with the outputs of the configurable hardware units, based on the at least one fabric select signal; and
a memory storage, the memory comprising instructions that, when executed, cause the device to:
generate a first hardware unit configuration signal and a first hardware unit fabric signal so as to operate at least a portion of the configurable hardware units and at least a portion of the configurable interconnect fabric in a first mode of operation during runtime, and
generate, during runtime, a second hardware unit configuration signal and a second hardware unit fabric signal so as to operate at least a portion of the configurable hardware units and at least a portion of the configurable interconnect fabric in a second mode of operation.

28. The device of claim 27, wherein the configurable hardware units include computing units for performing the computing operations.

29. The device of claim 27, wherein the configurable hardware units include data units for performing the storage operations.

30. The device of claim 29, wherein the device is configured such that at least one of the data units stores data generated during the first mode of operation, while at least a portion of the configurable hardware units including the at least one data unit is being configured to operate in the second mode of operation, so that the data is available during the second mode of operation.

31. The device of claim 27, wherein the configurable interconnect fabric includes a plurality of multiplexers.

32. The device of claim 27, wherein the device is configured such that a first portion of the device operates in the first mode of operation while a second portion of the device operates in the second mode of operation, such that the device simultaneously operates in the first mode of operation and the second mode of operation.

33. The device of claim 27, wherein the configurable hardware units further include at least one synchronization input for receiving a synchronization signal to initiate at least one of the computing operations or the storage operations.

34. The device of claim 27, wherein the device is further configured to issue different synchronization signals for different hardware units so as to coordinate the performance of at least one of the computing operations or the storage operations of the different hardware units.

35. The device of claim 27, wherein the at least portion of the configurable hardware units and the at least portion of the configurable interconnect fabric to operate in the first mode of operation are the same as the at least portion of the configurable hardware units and the at least portion of the configurable interconnect fabric to operate in the second mode of operation.

36. The device of claim 27, wherein the at least portion of the configurable hardware units and the at least portion of the configurable interconnect fabric to operate in the first mode of operation are different from the at least portion of the configurable hardware units and the at least portion of the configurable interconnect fabric to operate in the second mode of operation.

37. The device of claim 36, wherein the device is further configured to lock a first portion of at least one of the configurable hardware units or the configurable interconnect fabric, while a second portion of at least one of the configurable hardware units or the configurable interconnect fabric is being configured to operate in the second mode of operation, such that the device operates in the first mode of operation simultaneously with configuration of the device to operate in the second mode of operation.
